(19) United States
(12) Patent Application Publication
(10) Pub. No.: US 2022/0308345 A1
(43) Pub. Date: Sep. 29, 2022

(54) DISPLAY DEVICE

(71) Applicant: HONDA MOTOR CO., LTD., Tokyo (JP)

(72) Inventor: Jumpei MORITA, Tokyo (JP)

(21) Appl. No.: 17/665,695

(22) Filed: Feb. 7, 2022

(30) Foreign Application Priority Data
Mar. 23, 2021 (JP) 2021-048124

(51) Int. Cl. G02B 27/01; B60K 35/00

(52) U.S. Cl. CPC G02B 27/0101; B60K 35/00; B60K 2370/1529; B60K 2370/31; B60K 2370/52; G02B 2027/0138; B60K 2370/178; G02B 2027/014; G02B 2027/0141

(57) ABSTRACT

A display device to be installed in a moving body includes: a surrounding image acquisition unit configured to acquire a surrounding image of the moving body; an external environment recognizing unit configured to recognize an object around the moving body; a distance acquisition unit configured to acquire a distance between the object and the moving body; a synthetic image generation unit that generates a guide display for notifying presence of the object and generates a synthetic image by combining the guide display with the surrounding image at a position corresponding to the object recognized by the external environment recognizing unit; and an image display unit that displays the synthetic image, wherein the synthetic image generation unit combines the guide display with the surrounding image such that visibility of the guide display increases as the distance between the object and the moving body decreases.

### TECHNICAL FIELD

The present invention relates to display device, particularly to a display device to be installed in a moving body such as a vehicle.

### BACKGROUND ART

There is known a guide display device for a vehicle which displays a guide figure having an arrow shape to indicate the direction in which the vehicle should proceed such that the guide figure is superimposed on an actual image captured by an onboard camera (for example, JP2007-198962A). The guide figure is displayed to be transparent or translucent in an overlapping region in which the guide figure overlaps with an obstacle in the actual image and to be opaque in the other region. Thereby, without compromising both the visibility of the guide figure and the visibility of the obstacle, the guide figure can be displayed to be superimposed on the actual image.

The inventor of the present application came up with displaying a guide image indicating an obstacle so as to be superimposed on a surrounding image of a moving body to alert the user of the obstacle in a display device installed in the moving body, similarly to the display device for the vehicle disclosed in JP2007-198962A.

However, the inventor of the present application found that if the configuration were the same as that disclosed in JP2007-198962A, the guide display would be made transparent or translucent in the overlapping region in which the guide display overlaps with the obstacle, and this would reduce the visibility of the guide display.

To solve such a problem, it may be conceived to make the guide display corresponding to the obstacle opaque at all times without making it transparent or translucent. However, the inventor of the present application found that if the guide display were opaque at all times, when there are multiple obstacles around the moving body and hence there are multiple guide displays corresponding to the respective obstacles, the display could become complicated and it would become difficult for the user to understand which obstacle the user should pay attention to.

### SUMMARY OF THE INVENTION

In view of the foregoing background, a primary object of the present invention is to provide a display device to be installed in a moving body, which displays one or more guide displays superimposed on the surrounding image of the moving body while allowing the user to easily note the guide display to pay attention to.

To achieve the above object, one aspect of the present invention provides a display device (3, 103) to be installed in a moving body, comprising: a surrounding image acquisition unit (51) configured to acquire a surrounding image of the moving body (60); an external environment recognizing unit (41) configured to recognize an object around the moving body; a distance acquisition unit (53) configured to acquire a distance between the object and the moving body; a synthetic image generation unit (54) that generates a guide display (65, 165) for notifying presence of the object and generates a synthetic image (70) by combining the guide display with the surrounding image at a position corresponding to the object recognized by the external environment recognizing unit; and an image display unit (32) that displays the synthetic image, wherein the synthetic image generation unit combines the guide display with the surrounding image such that visibility of the guide display increases as the distance between the object and the moving body decreases.

According to this aspect, the guide display is displayed on the display device to be superimposed on the surrounding image of the moving body. Also, the visibility of the guide display is increased as the distance between the object and the moving body decreases. Thereby, the user can easily note the guide display that is near the moving body and hence attention should be paid to. This is particularly advantageous when there are multiple objects around the moving body and hence there are multiple guide displays superimposed on the surrounding image to correspond to the respective objects.

In the above aspect, preferably, the synthetic image generation unit combines the guide display with the surrounding image such that a transparency of the guide display decreases as the distance acquired by the distance acquisition unit decreases.

According to this aspect, the visibility of the guide display can be changed easily depending on the distance.

In the above aspect, preferably, the synthetic image generation unit combines the guide display with the surrounding image such that a color saturation of the guide display increases as the distance acquired by the distance acquisition unit decreases.

According to this aspect, the visibility of the guide display can be changed easily depending on the distance.

In the above aspect, preferably, the surrounding image includes a two-dimensional image (61) and the guide display is displayed to be superimposed on the two-dimensional image.

According to this aspect, the user can easily recognize the distance between the moving body and the object corresponding to the guide display in the surrounding image.

In the above aspect, preferably, the surrounding image includes a three-dimensional image (62) and the guide display is displayed to be superimposed on the three-dimensional image.

According to this aspect, the user can easily recognize the distance between the moving body and the object corresponding to the guide display in the surrounding image.

In the above aspect, preferably, the surrounding image includes images of front, rear, left, and right areas around the moving body with respect to a moving direction of the moving body.

According to this aspect, the front, rear, left, and right areas around the moving body are displayed on the display device. Such display on the display device allows the user to recognize the situation in a large range around the moving body.

In the above aspect, preferably, the surrounding image includes an image of an area in front of the moving body with respect to a moving direction of the moving body.

According to this aspect, the image of an area in the moving direction is displayed on the display device. Such display on the display device allows the user to easily grasp the situation in the moving direction of the moving body to which attention should be paid.

According to the foregoing configuration, it is possible to provide a display device to be installed in a moving body, which displays one or more guide displays to be super imposed on the surrounding image of the moving body while allowing the user to easily note the guide display to pay attention to.

### BRIEF DESCRIPTION OF THE DRAWINGS

FIG. 1 is a functional block diagram of a vehicle provided with a parking assist system according to a first embodiment of the present invention;

FIG. 2 is a flowchart of an automatic parking process executed by the parking assist system;

FIG. 3A is a diagram showing a screen display of a touch panel of the parking assist system according during a target parking position reception process;

FIG. 3B is a diagram showing the screen display of the touch panel during a driving process;

FIG. 3C is a diagram showing the screen display of the touch panel when movement of the vehicle to the parking position is completed;

FIG. 4 is a flowchart of a display process according to the first embodiment;

FIG. 5A is a diagram showing a display screen of a touch panel of an HMI of a display device for a vehicle according to the first embodiment when there is an object around the vehicle;

FIG. 5B is a diagram showing the display screen of the touch panel of the HMI of the display device when there is an object at a position more distant from the vehicle than in FIG. 5A;

FIG. 6 is a flowchart of a display process according to the second embodiment of the present invention;

FIG. 7A is a diagram showing a display screen of a touch panel of an HMI of a display device for a vehicle according to the second embodiment when there is an object around the vehicle; and

FIG. 7B is a diagram showing the display screen of the touch panel of the HMI of the display device where there is an object at a position more distant from the vehicle than in FIG. 7A.

### DETAILED DESCRIPTION OF THE INVENTION

In the following, an embodiment of the present invention will be described in detail with reference to the drawings.

### First Embodiment

A parking assist system 1 is mounted on a vehicle such as an automobile provided with a vehicle control system 2 configured to make the vehicle travel autonomously.

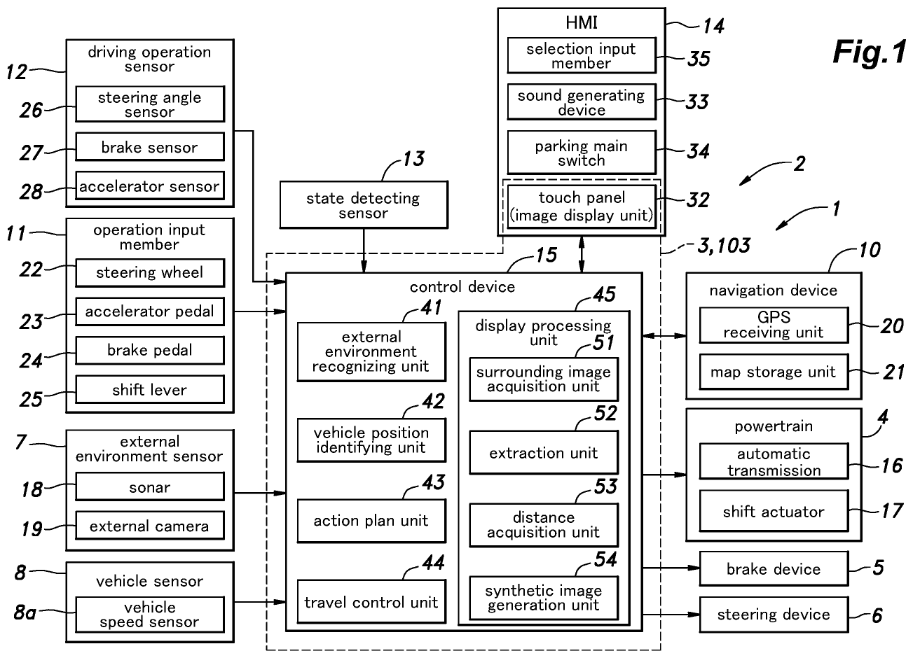

As shown in FIG. 1, the vehicle control system 2 includes a powertrain 4, a brake device 5, a steering device 6, an external environment sensor 7, a vehicle sensor 8, a navigation device 10, an operation input member 11, a driving operation sensor 12, a state detecting sensor 13, a human machine interface (HMI) 14, and a control device 15. The above components of the vehicle control system 2 are connected to each other so that signals can be transmitted therebetween via communication means such as a Controller Area Network (CAN).

The powertrain 4 is a device configured to apply a driving force to the vehicle. The powertrain 4 includes a power source and a transmission, for example. The power source includes at least one of an internal combustion engine, such as a gasoline engine and a diesel engine, and an electric motor. In the present embodiment, the powertrain 4 includes an automatic transmission 16 and a shift actuator 17 for changing a shift position of the automatic transmission 16 (a shift position of the vehicle). The brake device 5 is a device configured to apply a brake force to the vehicle. For example, the brake device 5 includes a brake caliper configured to press a brake pad against a brake rotor and an electric cylinder configured to supply an oil pressure to the brake caliper. The brake device 5 may include an electric parking brake device configured to restrict rotations of wheels via wire cables. The steering device 6 is a device for changing a steering angle of the wheels. For example, the steering device 6 includes a rack-and-pinion mechanism configured to steer (turn) the wheels and an electric motor configured to drive the rack-and-pinion mechanism. The powertrain 4, the brake device 5, and the steering device 6 are controlled by the control device 15.

The external environment sensor 7 serves as an external environment information acquisition device for detecting electromagnetic waves, sound waves, and the like from the surroundings of the vehicle to detect an object outside the vehicle and to acquire surrounding information of the vehicle. The external environment sensor 7 includes sonars 18 and external cameras 19. The external environment sensor 7 may further include a millimeter wave radar and/or a laser lidar. The external environment sensor 7 outputs a detection result to the control device 15.

Each sonar 18 consists of a so-called ultrasonic sensor. Each sonar 18 emits ultrasonic waves to the surroundings of the vehicle and captures the ultrasonic waves reflected by an object around the vehicle thereby to detect a position (distance and direction) of the object. Multiple sonars 18 are provided at each of a rear part and a front part of the vehicle. In the present embodiment, two pairs of sonars 18 are provided on a rear bumper so as to be spaced laterally from each other, two pairs of sonars 18 are provided on a front bumper so as to be spaced laterally from each other, one pair of sonars 18 is provided at a front end portion of the vehicle such that the two sonars 18 forming the pair are provided on left and right side faces of the front end portion of the vehicle, and one pair of sonars 18 is provided at a rear end portion of the vehicle such that the two sonars 18 forming the pair are provided on left and right side faces of the rear end portion of the vehicle. That is, the vehicle is provided with six pairs of sonars 18 in total. The sonars 18 provided on the rear bumper mainly detect positions of objects behind the vehicle. The sonars 18 provided on the front bumper mainly detect positions of objects in front of the vehicle. The sonars 18 provided at the left and right side faces of the front end portion of the vehicle detect positions of objects on left and right outsides of the front end portion of the vehicle, respectively. The sonars 18 provided at the left and right side faces of the rear end portion of the vehicle detect positions of objects on left and right outsides of the rear end portion of the vehicle, respectively.

The external cameras 19 are devices configured to capture images around the vehicle. Each external camera 19 consists of a digital camera using a solid imaging element such as a CCD or a CMOS, for example. The external cameras 19 include a front camera for capturing an image in front of the vehicle and a rear camera for capturing an image to the rear of the vehicle. The external cameras 19 may include a pair of left and right side cameras that are provided in the vicinity of the door mirrors of the vehicle to capture images on left and right sides of the vehicle.

The vehicle sensor 8 includes a vehicle speed sensor 8a configured to detect the speed of the vehicle, an acceleration sensor configured to detect the acceleration of the vehicle, a yaw rate sensor configured to detect the angular velocity around a vertical axis of the vehicle, and a direction sensor configured to detect the direction of the vehicle. The vehicle speed sensor 8a may be constituted of multiple wheel speed sensors configured to detect respective wheel speeds (rotation speeds of the respective wheels), for example. The yaw rate sensor may be a gyro sensor, for example.

The navigation device 10 is a device configured to obtain a current position of the vehicle and provides route guidance to a destination and the like. The navigation device 10 includes a GPS receiving unit 20 and a map storage unit 21. The GPS receiving unit 20 identifies a position (latitude and longitude) of the vehicle based on a signal received from an artificial satellite (positioning satellite). The map storage unit 21 consists of a known storage device such as a flash memory or a hard disk, and stores map information.

The operation input member 11 is provided in a vehicle cabin to receive an input operation performed by the occupant (user) to control the vehicle. The operation input member 11 includes a steering wheel 22, an accelerator pedal 23, a brake pedal 24 (brake input member), and a shift lever 25 (a shift member). The shift lever 25 is configured to receive an operation for selecting the shift position of the vehicle.

The driving operation sensor 12 detects an operation amount of the operation input member 11. The driving operation sensor 12 includes a steering angle sensor 26 configured to detect a steering angle of the steering wheel 22, a brake sensor 27 configured to detect a pressing amount of the brake pedal 24, and an accelerator sensor 28 configured to detect a pressing amount of the accelerator pedal 23. The driving operation sensor 12 outputs a detected operation amount to the control device 15.

The HMI 14 is an input/output device for receiving an input operation by the occupant and notifying the occupant of various kinds of information by display and/or voice. The HMI 14 includes, for example, a touch panel 32 that includes a display screen such as a liquid crystal display or an organic EL display and is configured to receive the input operation by the occupant, a sound generating device 33 such as a buzzer or a speaker, a parking main switch 34, and a selection input member 35. The parking main switch 34 receives the input operation by the occupant to execute selected one of an automatic parking process (autonomous parking operation) and an automatic unparking process (autonomous unparking operation). The parking main switch 34 is a so-called momentary switch that is turned on only while a pressing operation (pushing operation) is performed by the occupant. The selection input member 35 receives a selection operation by the occupant related to selection of the automatic parking process and the automatic unparking process. The selection input member 35 may consist of a rotary select switch, which preferably requires pressing as the selection operation.

The control device 15 consists of an electronic control unit (ECU) that includes a CPU, a nonvolatile memory such as a ROM, a volatile memory such as a RAM, and the like. The CPU executes operation processing according to a program so that the control device 15 executes various types of vehicle control. The control device 15 may consist of one piece of hardware, or may consist of a unit including multiple pieces of hardware. Further, the functions of the control device 15 may be at least partially executed by hardware such as an LSI, an ASIC, and an FPGA, or may be executed by a combination of software and hardware.

The parking assist system 1 is a system for executing the so-called automatic parking process and the so-called automatic unparking process, in which a vehicle is moved autonomously to a prescribed target position (a target parking position or a target unparking position) selected by the occupant so as to park or unpark the vehicle.

The parking assist system 1 includes the powertrain 4, the brake device 5, the steering device 6, the vehicle sensor 8, the HMI 14, and the control device 15. The touch panel 32 of the HMI 14 (one example of an image display unit) and the control device 15 constitute a display device 3 for the vehicle.

The control device 15 controls the powertrain 4, the brake device 5, and the steering device 6 so as to execute an autonomous parking operation to move the vehicle autonomously to a target parking position and park the vehicle at the target parking position and an autonomous unparking operation to move the vehicle autonomously to a target unparking position and unpark the vehicle at the target unparking position. In order to execute such operations, the control device 15 includes an external environment recognizing unit 41, a vehicle position identifying unit 42, an action plan unit 43, a travel control unit 44, and a display processing unit 45.

The external environment recognizing unit 41 recognizes, as targets, objects (for example, a person or an obstacle) that are present around the vehicle based on the detection result of the external environment sensor 7 and obtains information (such as the position and size) of each detected object. For instance, the external environment recognizing unit 41 acquires the position of each object by using the signal from the sonars 18.

Also, by the analysis of the detection result of the external environment sensor 7 (more specifically, by the analysis of the images captured by the external cameras 19 based on a known image analysis method such as pattern matching), the external environment recognizing unit 41 can acquire, for example, a lane on a road delimited by road signs and a parking space delimited by white lines and the like provided on a surface of a road, a parking lot, and the like.

The vehicle position identifying unit 42 identifies the position of the vehicle (the own vehicle) based on a signal from the GPS receiving unit 20 of the navigation device 10. Further, the vehicle position identifying unit 42 may obtain the vehicle speed and the yaw rate from the vehicle sensor 8, in addition to the signal from the GPS receiving unit 20, and identify the position and posture of the vehicle by the so-called inertial navigation.

The travel control unit 44 controls the powertrain 4, the brake device 5, and the steering device 6 based on a travel control instruction from the action plan unit 43 to make the vehicle travel.

While the automatic parking is being executed, the display processing unit 45 generates an image to be displayed on the touch panel 32 of the HMI 14 and displays the generated image on the touch panel 32. The display processing unit 45 includes a surrounding image acquisition unit 51, an extraction unit 52, a distance acquisition unit 53, and a synthetic image generation unit 54.

The surrounding image acquisition unit 51 acquires surrounding images 60 of the vehicle by using the images captured by the external cameras 19. The surrounding images 60 include a look-down image 61 and a bird's-eye image 62. The look-down image 61 corresponds to a two-dimensional image showing the vehicle and its surroundings in plan view. The bird's-eye image 62 corresponds to a three-dimensional image showing the vehicle and a part of its surroundings positioned in the travel direction (namely, in the moving direction of the vehicle) as viewed from obliquely above. The surrounding image acquisition unit 51 may generate the look-down image 61 by combining the images of the front camera, the rear camera, and the left and right side cameras, and may generate the bird's-eye image 62 by combining the image captured by the front camera or the rear camera facing in the travel direction and the mages captured by the left and right side cameras.

The extraction unit 52 extracts an image of each object recognized by the external environment recognizing unit 41 from within the surrounding images 60 acquired by the surrounding image acquisition unit 51 if the image of the object is included in the surrounding images 60. The extraction unit 52 may extract an outline of the image of each object from within the surrounding images 60 based on the position of each object and other information acquired by the external environment recognizing unit 41.

The distance acquisition unit 53 acquires a distance between the vehicle and each of the objects extracted by the extraction unit 52 based on the position of each object and other information acquired by the external environment recognizing unit 41.

To allow the user easily recognize presence of the objects around the vehicle, the synthetic image generation unit 54 generates a synthetic image 70 in which guide displays 65 are superimposed on at least one of the surrounding images 60 (for example, the look-down image 61). The guide displays 65 are for notifying presence of the objects around the vehicle, and each may be a rectangular frame or a rectangular U-shaped frame that entirely or partially surrounds the corresponding object in the look-down image 61, for example. Besides, each guide display 65 may be a figure resembling a wall body or a rectangular cuboid provided at a position corresponding to the image of the associated object in the bird's-eye image 62.

The synthetic image generation unit 54 generates the synthetic image 70 by superimposing the guide displays 65 on at least one of the surrounding images 60 at positions corresponding to the images of the objects recognized by the external environment recognizing unit 41 in the surrounding image 60. Note that the synthetic image generation unit 54 sets the visibility of each guide display 65 such that the visibility increases as the distance between the corresponding object and the vehicle decreases.

Specifically, the synthetic image generation unit 54 sets the transparency of each guide display 65 such that the transparency decreases (namely, the guide display 65 becomes less transmissive) as the distance between the corresponding object and the vehicle decreases. Note that the synthetic image generation unit 54 is not limited to this mode, and the synthetic image generation unit 54 may set the color saturation of each guide display 65 such that the color saturation increases (namely, the guide display 65 becomes brighter) as the distance between the corresponding object and the vehicle decreases, for example.

The action plan unit 43 executes the automatic parking process (autonomous parking operation) or the automatic unparking process (autonomous unparking operation) when the vehicle is in a prescribed state and the HMI 14 or the parking main switch 34 receives a prescribed input by the user, which corresponds to a request for the automatic parking process or the automatic unparking process. More specifically, the action plan unit 43 executes the automatic parking process in a case where a prescribed input corresponding to the automatic parking process is performed when the vehicle is stopped or the vehicle is traveling at a low speed equal to or less than a prescribed vehicle speed (a vehicle speed at which a parking position candidate can be searched for). The action plan unit 43 executes the automatic unparking process (parallel unparking process) in a case where a prescribed input corresponding to the automatic unparking process is performed when the vehicle is stopped. The selection of the process to be executed (the automatic parking process or the automatic unparking process) may be made by the action plan unit 43 based on the state of the vehicle. Alternatively, the above selection may be made by the occupant via the touch panel 32 or the selection input member 35. When executing the automatic parking process, the action plan unit 43 first makes the touch panel 32 display a parking search screen for setting the target parking position. After the target parking position is set, the action plan unit 43 makes the touch panel 32 display a parking screen. When executing the automatic unparking process, the action plan unit 43 first makes the touch panel 32 display an unparking search screen for setting the target unparking position. After the target unparking position is set, the action plan unit 43 makes the touch panel 32 display an unparking screen.

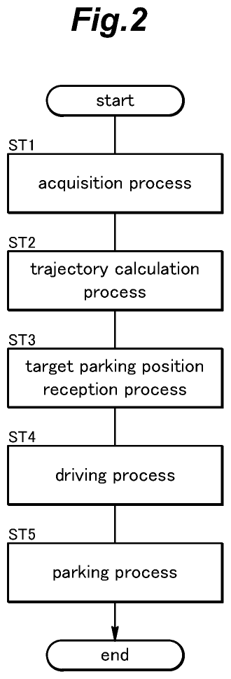

In the following, the automatic parking process will be described with reference to FIG. 2. The action plan unit 43 first executes an acquisition process (step ST1) to acquire one or more parking spaces, if any. More specifically, in a case where the vehicle is stopped, the action plan unit 43 first makes the touch panel 32 of the HMI 14 display a notification that instructs the occupant to move the vehicle straight. While the occupant sitting in the driver's seat (hereinafter referred to as “driver”) is moving the vehicle straight, the external environment recognizing unit 41 acquires, based on a signal from the external environment sensor 7, a position and size of each detected obstacle and positions of the white lines provided on the road surface. The external environment recognizing unit 41 extracts, based on the acquired position and size of the obstacle and the acquired positions of the white lines, one or more undelimited parking spaces and one or more delimited parking spaces, if any (hereinafter, the undelimited parking spaces and the delimited parking spaces will be collectively referred to as “parking spaces”). Each undelimited parking space is a space that is not delimited by the white lines or the like, has a size sufficient to park the vehicle, and is available (namely, there is no obstacle therein). Each delimited parking space is a space that is delimited by the white lines or the like, has a size sufficient to park the vehicle, and is available (namely, another vehicle (vehicle other than the own vehicle) is not parked).

Next, the action plan unit 43 executes a trajectory calculation process (step ST2) to calculate a trajectory of the vehicle from a current position of the vehicle to each extracted parking space. In a case where the trajectory of the vehicle can be calculated for a certain parking space, the action plan unit 43 sets the parking space as a parking position candidate where the vehicle can be parked, and make the touch panel 32 display the parking position candidate on the screen (the parking search screen). In a case where the trajectory of the vehicle cannot be calculated due to the presence of the obstacle, the action plan unit 43 does not set the parking space as a parking position candidate and does not make the touch panel 32 display the parking space on the screen. When the action plan unit 43 sets multiple parking position candidates (namely, multiple parking places for which the trajectory of the vehicle can be calculated), the action plan unit 43 makes the touch panel 32 display these parking position candidates.

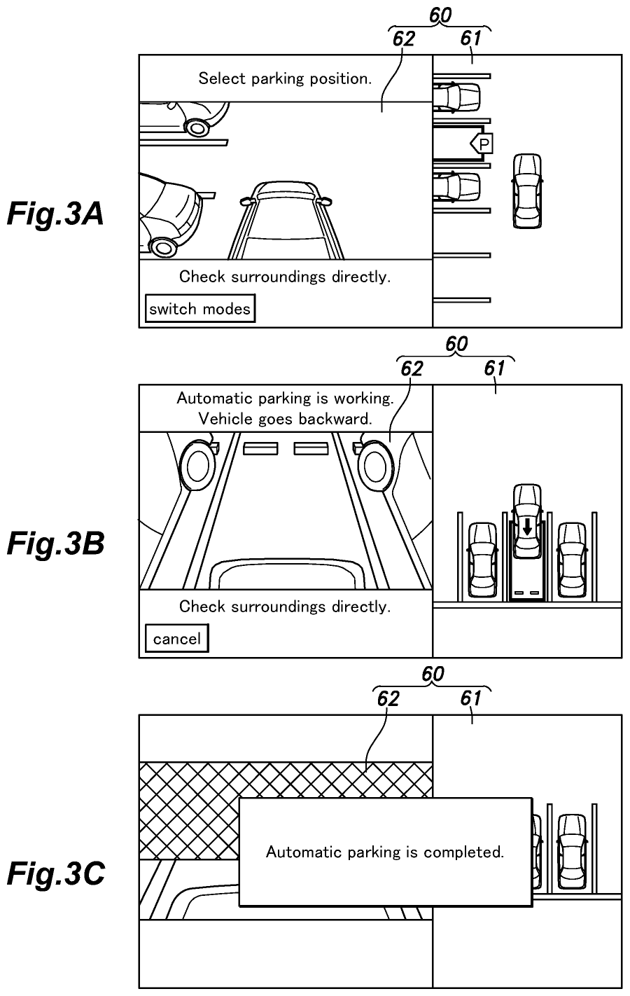

Next, the action plan unit 43 executes a target parking position reception process (step ST3) to receive a selection operation performed by the occupant to select the target parking position, which is a parking position where the occupant wants to park the vehicle, and is selected from the one or more parking position candidates displayed on the touch panel 32. More specifically, the action plan unit 43 makes the touch panel 32 display the surrounding images 60 on the parking search screen shown in FIG. 3A. The surrounding images 60 include the look-down image 61 and the bird's-eye image 62 in the traveling direction. When the action plan unit 43 acquires at least one parking position candidate, the action plan unit 43 makes the touch panel 32 display a frame that indicates the parking position candidate and an icon that corresponds to the frame in at least one of these surrounding images 60 (in the look-down image in FIG. 3A) in a superimposed manner. The icon consists of a symbol indicating the parking position candidate (see “P” in FIG. 3A). Also, the action plan unit 43 makes the touch panel 32 display, in the parking search screen, a notification that instructs the driver to stop the vehicle and select the target parking position, so that the touch panel 32 receives the selection operation of the target parking position. The selection operation of the target parking position may be performed via the touch panel 32, or may be performed via the selection input member 35.

After the vehicle is stopped and the target parking position is selected by the driver, the action plan unit 43 makes the touch panel 32 switch the screen from the parking search screen to the parking screen. As shown in FIG. 3B, the parking screen is a screen in which an image in the travel direction of the vehicle (hereinafter referred to as “travel direction image”) is displayed on the left half of the touch panel 32 and the look-down image 61 including the vehicle and its surrounding area is displayed on the right half thereof. At this time, the action plan unit 43 may make the touch panel 32 display a thick frame that indicates the target parking position selected from the parking position candidates and an icon that corresponds to the thick frame such that the thick frame and the icon overlap with the look-down image 61. This icon consists of a symbol indicating the target parking position, and is shown in a color different from the symbol indicating the parking position candidate.

After the target parking position is selected and the screen of the touch panel 32 is switched to the parking screen, the action plan unit 43 executes a driving process (step ST4) to make the vehicle travel along the calculated trajectory. At this time, the action plan unit 43 controls the vehicle based on the position of the vehicle acquired by the GPS receiving unit 20 and the signals from the external cameras 19, the vehicle sensor 8, and the like so that the vehicle travels along the calculated trajectory. At this time, the action plan unit 43 controls the powertrain 4, the brake device 5, and the steering device 6 so as to execute a switching operation for switching the travel direction of the vehicle (a reversing operation for reversing the travel direction of the vehicle). The switching operation may be executed repeatedly, or may be executed only once.

During the driving process, the action plan unit 43 may acquire the travel direction image from the external cameras 19 and make the touch panel 32 display the acquired travel direction image on the left half thereof. For example, as shown in FIG. 3B, when the vehicle is moving backward, the action plan unit 43 may make the touch panel 32 display an image to the rear of the vehicle captured by the external cameras 19 on the left half thereof. While the action plan unit 43 is executing the driving process, the surrounding image of the vehicle (the own vehicle) in the look-down image 61 displayed on the right half of the touch panel 32 changes along with the movement of the vehicle. When the vehicle reaches the target parking position, the action plan unit 43 stops the vehicle and ends the driving process.

When the driving process ends, the action plan unit 43 executes a parking process (step ST5). In the parking process, the action plan unit 43 first drives the shift actuator 17 to set the shift position (shift range) to a parking position (parking range). Thereafter, the action plan unit 43 drives the parking brake device, and makes the touch panel 32 display a pop-up window (see FIG. 3C) indicating that the automatic parking of the vehicle has been completed. The pop-up window may be displayed on the screen of the touch panel 32 for a prescribed period. Thereafter, the action plan unit 43 may make the touch panel 32 switch the screen to an operation screen of the navigation device 10 or a map screen.

In the parking process, there may be a case where the shift position cannot be changed to the parking position because of an abnormality of the shift actuator 17 or a case where the parking brake device cannot be driven because of an abnormality of the parking brake device. In these cases, the action plan unit 43 may make the touch panel 32 display the cause of the abnormality on the screen thereof

### (Display Process)

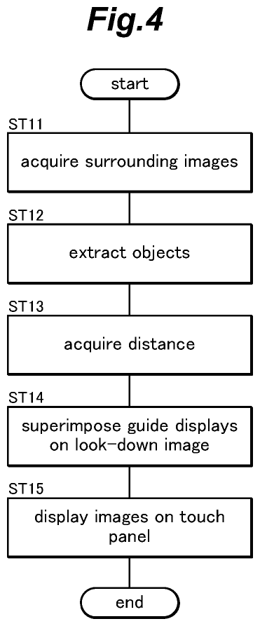

While the action plan unit 43 is executing the driving process, the display processing unit 45 executes a display process repeatedly to display information on the surroundings of the vehicle on the touch panel 32 of the HMI 14. In the following, the display process will be described in detail with reference to FIG. 4.

In the first step ST11 of the display process, the display processing unit 45 (the surrounding image acquisition unit 51) acquires the surrounding images 60 of the vehicle by using the images captured by the external cameras 19. The surrounding images 60 include the look-down image 61 and the bird's-eye image 62. When the acquisition of the surrounding images 60 is completed, the display processing unit 45 executes step ST12.

In step ST12, the display processing unit 45 (the extraction unit 52) extracts the images of objects from within the acquired surrounding images 60. When the extraction of the images of the objects is completed, the display processing unit 45 executes step ST13.

In step ST13, the display processing unit 45 (the distance acquisition unit 53) collate the images of the objects extracted from within the surrounding images 60 in step ST12 based on the positions of the objects acquired by the external environment recognizing unit 41, thereby to acquire the distance between each object and the vehicle. When the acquisition of distance is completed, the display processing unit 45 executes step ST14.

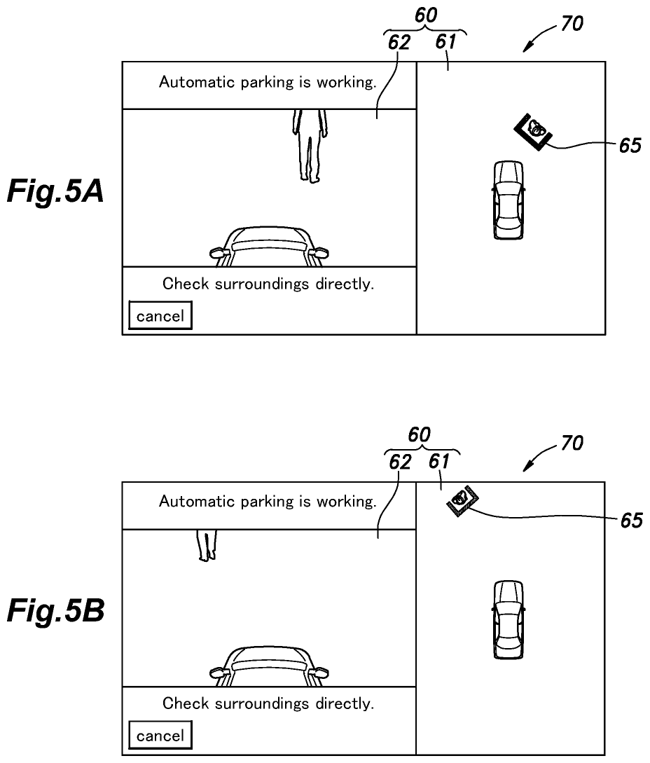

In step ST14, the display processing unit 45 (the synthetic image generation unit 54) generates the synthetic image 70 in which the guide displays 65 corresponding to the images of the respective objects are superimposed on the look-down image 61. As shown in FIGS. 5A and 5B, the guide displays 65 are substantially rectangular U-shaped frames partially surrounding the images of the respective objects in the look-down image 61. When combining the guide displays 65 with the look-down image 61, the display processing unit 45 sets the transparency of each guide display 65 such that the transparency decreases as the distance between the corresponding object between the vehicle decreases. When the generation of the synthetic image 70 is completed, the display processing unit 45 executes step ST15.

In step ST15, the display processing unit 45 displays the bird's-eye image 62 and the synthetic image 70 on the touch panel 32 of the HMI 14. When the display is completed, the display processing unit 45 ends the display process.

Next, the effects of the display device 3 for the vehicle configured as described above will be described.

The display processing unit 45 executes the display process repeatedly while the driving process is being executed. Thereby, while the vehicle is moving in the driving process, the bird's-eye image 62 and the look-down image 61 around the vehicle on which the guide displays 65 are superimposed are displayed on the touch panel 32 of the HMI 14.

As shown in FIGS. 5A and 5B, each guide display 65 is displayed such that the transparency thereof decreases as the distance between the corresponding object and the vehicle decreases. Thereby, as an object comes closer to the vehicle, the transparency of the guide display 65 corresponding to the object decreases and the visibility of the same increases. Therefore, it is easy for the user to visually recognize the guide display 65 corresponding to the object that is near the vehicle and hence attention should be paid to by the user. Thus, the user can easily understand the presence of an object to pay attention to, and this improves the safety of the vehicle.

Since the transparency of the guide display 65 is changed depending on the distance, the visibility of the guide display 65 can be changed easily without changing the shape or size of the guide display 65.

In addition, the surrounding images 60 displayed on the touch panel 32 includes the look-down image 61 which is a two-dimensional image, and the guide displays 65 are displayed to be superimposed on the look-down image 61. Thereby, with the look-down image 61, the user can sensuously understand the distance between the vehicle and each object positioned around the vehicle.

The look-down image 61 includes image information of the front, rear, left, and right areas around the vehicle. Therefore, while the vehicle is moving in the driving process, the image information of the front, rear, left, and right areas around the vehicle is displayed on the touch panel 32 of the HMI 14. As a result, the user can easily recognize the situation around the vehicle owing to the display on the touch panel 32 of the HMI 14.

### Second Embodiment

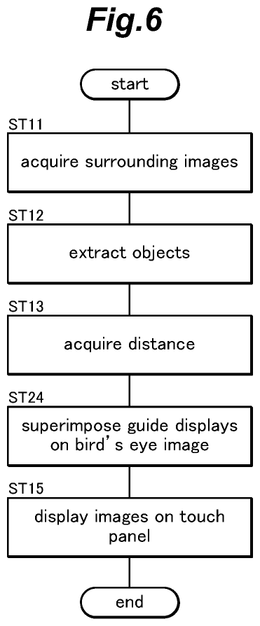

A display device 103 for a vehicle according to the second embodiment of the present invention differs from the first embodiment with regard to the process of step ST12 and the process of step ST13 executed by the display processing unit 45 in the display process. Further, as shown in the flowchart of FIG. 6, the second embodiment differs from the first embodiment in that the display processing unit 45 executes step ST24 instead of step ST14. The other configuration is the same as in the first embodiment. Thus, description of the other configuration will be omitted.

In step ST12 of the display process, the display processing unit 45 extracts images of objects from within the bird's-eye image 62. When the extraction is completed, the display processing unit 45 executes step ST13 to acquire the distance between each of the objects extracted in step ST12 and the vehicle similarly to the first embodiment. Thereafter, the display processing unit 45 executes step ST24.

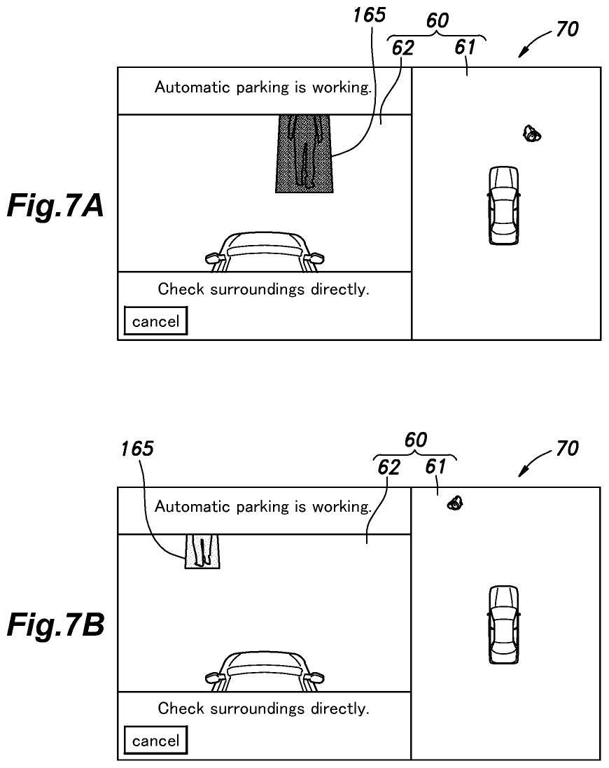

In step ST24 of the display process, the display processing unit 45 generates a synthetic image 70 in which guide displays 165 corresponding to the respective objects are superimposed on the bird's-eye image 62. As shown in FIGS. 7A and 7B, the display processing unit 45 displays each guide display 165 as a virtual wall body that stands upright to be in contact with a vehicle-side side surface of the corresponding object in the bird's-eye image 62. When combining the guide displays 165 with the bird's-eye image 62, the display processing unit 45 sets the transparency of each guide display 165 such that the transparency decreases as the distance between the corresponding object and the vehicle decreases. When the generation of the synthetic image 70 is completed, the display processing unit 45 executes step ST15.

Next, the effects of the display device 103 for the vehicle configured as described above will be described.

While the vehicle is moving in the driving process, the bird's-eye image 62 in the vehicle travel direction and the look-down image 61 are displayed on the touch panel 32 of the HMI 14. As shown in FIGS. 7A and 7B, the bird's-eye image 62 includes the guide displays 165 superimposed thereon.

Similarly to the first embodiment, as shown in FIGS. 7A and 7B, each guide display 165 is displayed such that the transparency thereof decreases as the distance between the corresponding object and the vehicle decreases. Therefore, it is easy for the user to visually recognize the guide display 165 corresponding to the object that is near the vehicle and hence attention should be paid to by the user. Thus, the user can easily understand the presence of an object to pay attention to, and this improves the safety of the vehicle. Also, since the transparency of the guide display 165 is changed depending on the distance, the visibility of the guide display 165 can be changed easily without changing the shape or size of the guide display 165.

In addition, the surrounding images 60 displayed on the touch panel 32 include the bird's-eye image 62 which is a three-dimensional image, and the guide displays 165 are displayed to be superimposed on the bird's-eye image 62. Thereby, with the bird's-eye image 62, the user can sensuously understand the distance between the vehicle and each object positioned around the vehicle.

The bird's eye image 62 includes an image of an area in the moving direction of the vehicle. Therefore, while the vehicle is moving in the driving process, the image in the moving direction of the vehicle is displayed on the touch panel 32 of the HMI 14. As a result, the user can easily grasp the situation in the moving direction of the vehicle to which attention should be paid owing to the display on the touch panel 32 of the HMI 14.

In the present embodiment, since the guide display is displayed in the bird's-eye image 62, it is possible to bring the user's attention to a part of the bird's-eye image 62 in the travel direction of the vehicle where the guide display is displayed. Thereby, it is possible to bring the user's attention to the area in the travel direction of the vehicle that should be checked, and this improves the safety of the vehicle.

Concrete embodiments of the present invention have been described in the foregoing, but the present invention is not limited to the above embodiments and may be modified or altered in various ways.

For example, in the above embodiments, the display processing unit 45 (the synthetic image generation unit 54) was configured such that as the distance between the vehicle and each object acquired by the distance acquisition unit 53 decreases, the transparency of the guide display 65, 165 corresponding to the object decreases. However, the method of changing the guide display 65, 165 depending on the distance (namely, the way of displaying the distance by the guide display 65, 165) is not limited to this mode.

The method of displaying the distance by the guide display 65, 165 is not particularly limited as long as the display processing unit 45 (the synthetic image generation unit 54) increases the visibility of the guide display 65, 165 as the distance between the vehicle and the object associated with the guide display 65, 165 decreases and combines the guide display 65, 165 with the surrounding image 60. For example, the display processing unit 45 (the synthetic image generation unit 54) may combine the guide displays 65, 165 with the surrounding image 60 such that as the distance between the vehicle and each object acquired by the acquisition unit 53 decreases, the color saturation of the guide display 65, 165 corresponding to the object increases. Thereby, as in the above embodiments, the user can easily note the guide display 65, 165 corresponding to the object that is near the vehicle and hence attention should be paid to, and the visibility of the guide display 65, 165 can be easily changed depending on the distance.

In the above embodiments, the guide displays 65, 165 were in the form of a frame or a wall body, but the guide displays 65, 165 are not limited to them. Each guide display 65, 165 may be in any form so long as it can indicate the position of the corresponding object in the surrounding image 60 and may be in the form of an arrow pointing to the image of the corresponding object, a circle surround the image of the corresponding object, a line depicting the outline of the object, the number indicating the distance between the corresponding object and the vehicle, characters (letters) describing the character of the object, or a symbol calling attention, for example.

In the above embodiments, the look-down image 61 and the bird's-eye image 62 were each configured based on the images captured by the external cameras 19, but the present invention is not limited to this. For example, the look-down image 61 or the bird's-eye image 62 may be configured based on the information acquired by any acquisition device (such as a sensor or a camera) configured to acquire information regarding the environment outside the vehicle, and the acquisition device may include, for example, a lidar, a radar, a sonar, an infrared camera, etc. Also, the look-down image 61 and the bird's-eye image 62 may be acquired by using multiple acquisition devices. The acquisition devices are not limited to those installed in the vehicle and may include those installed in a parking lot, for example.

Also, the look-down image 61 may be in any image depicting the surroundings of the vehicle two-dimensionally (in the present description, including an image artificially representing the surroundings of the vehicle two-dimensionally, such as an illustration, a schematic diagram, and the like). Also, the bird's-eye image 62 may be any image depicting an area in the moving direction of the vehicle three-dimensionally (in the present description, including an image artificially representing the surroundings of the vehicle three-dimensionally, for example, such as an illustration, a schematic diagram, and the like).

In the above embodiments, the surrounding images 60 were displayed on the touch panel 32 of the HMI 14, but the present invention is not limited to this mode. The surrounding images 60 may be displayed on the screen of an operation terminal, such as a smartphone, a tablet, or a personal computer (PC), for operating the vehicle remotely.

In the above embodiments, the visibility of the guide display 65, 165 was changed depending on the distance between the vehicle and the object, but the present invention is not limited to this mode. The visibility of the guide display 65, 165 may be increased as the degree of attention to be paid by the user increases. For example, the synthetic image generation unit 54 may increase the visibility of the guide display 65, 165 when the object is a moving object such as a child or a small animal compared to the object is stationary and superimpose the guide display on the look-down image 61 or the bird's-eye image 62. More specifically, the synthetic image generation unit 54 may increase the visibility as the moving speed of the image of the object in the look-down image 61 or the bird's-eye image 62 becomes higher.

Also, the synthetic image generation unit 54 may increase the visibility of the guide display 65, 165 by decreasing the transparency of the guide display 65, 165 or by any other way as the moving speed of the object itself becomes higher and superimpose the guide display on the look-down image 61 or the bird's-eye image 62. The moving speed of the object itself may be the speed measured by a lidar, a radar, a sonar, and the like. By changing the visibility of the guide display 65, 165 based on the moving speed of the object itself, even in an exemplary case where an object is moving toward the vehicle but the image of the object is not moving in the bird's-eye image 62, it is possible to notify to the user, with the guide display 65, 165, that the object is moving and attention should be paid thereto.

In the above embodiments, description was made of an example in which the present invention was applied to the parking assist system 1 for parking the vehicle, but the present invention is not limited to this. The present invention may be applied to a stop assist system capable of moving and stopping a movable object (moving body), such as an automobile, a motorcycle, a unicycle, a watercraft, an aircraft, and the like.

1. A display device to be installed in a moving body, comprising:
a surrounding image acquisition unit configured to acquire a surrounding image of the moving body;
an external environment recognizing unit configured to recognize an object around the moving body;
a distance acquisition unit configured to acquire a distance between the object and the moving body;
a synthetic image generation unit that generates a guide display for notifying presence of the object and generates a synthetic image by combining the guide display with the surrounding image at a position corresponding to the object recognized by the external environment recognizing unit; and
an image display unit that displays the synthetic image,
wherein the synthetic image generation unit combines the guide display with the surrounding image such that visibility of the guide display increases as the distance between the object and the moving body decreases.

2. The display device according to claim 1, wherein the synthetic image generation unit combines the guide display with the surrounding image such that a transparency of the guide display decreases as the distance acquired by the distance acquisition unit decreases.

3. The display device according to claim 1, wherein the synthetic image generation unit combines the guide display with the surrounding image such that a color saturation of the guide display increases as the distance acquired by the distance acquisition unit decreases.

4. The display device according to claim 1, wherein the surrounding image includes a two-dimensional image and the guide display is displayed to be superimposed on the two-dimensional image.

5. The display device according to claim 1, wherein the surrounding image includes a three-dimensional image and the guide display is displayed to be superimposed on the three-dimensional image.

6. The display device according to claim 1, wherein the surrounding image includes images of front, rear, left, and right areas around the moving body with respect to a moving direction of the moving body.

7. The display device according to claim 1, wherein the surrounding image includes an image of an area in front of the moving body with respect to a moving direction of the moving body.
